(19) United States
(12) Patent Application Publication
(10) Pub. No.: US 2017/0144098 A1
(43) Pub. Date: May 25, 2017

(54) Air Handler Cleaning Receptacle

(71) Applicant: ERNESTO RODRIGUEZ, DORAL, FL (US)

(72) Inventor: ERNESTO RODRIGUEZ, DORAL, FL (US)

(21) Appl. No.: 14/952,605

(22) Filed: Nov. 25, 2015

(51) Int. Cl. B01D 46/48; B01D 46/00

(52) U.S. Cl. CPC B01D 46/48; B01D 46/0002

(57) ABSTRACT

An air handler cleaning receptacle collects fluid and waste that leak from an HVAC unit, or that accumulate while cleaning components of air handler. The receptacle detachably attaches inside the air handler, such that it can be reused, carried easily, and adapted for operation with variously sized air handlers. The receptacle attaches to a filter rack in the air handler, and slide in and out of the filter rack during operation and after use. The receptacle not only captures excess fluid and waste, but also funnels the fluid and waste to a discharge container for disposal. A panel frame slides into the filter rack. A panel extends across the panel frame. A tube extends from the panel to carry the fluid to a discharge container. At least two holes receive a hook for mounting the receptacle. Magnetic fasteners also enable mounting the receptacle in the air handler.

### BACKGROUND

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The present invention is directed to an air handler cleaning receptacle that collects fluid and waste that leak from an HVAC unit, or that accumulate while cleaning an air handler.

Those skilled in the art will recognize that the air handler is a device used to regulate and circulate air as part of a heating, ventilating, and air-conditioning (HVAC) system. The air handler is usually a large metal box containing a blower, a heating or cooling mechanism, a cooling and heating coil, a filter rack for retaining a filter, and a sound attenuator and damper. The air handler connects to a ductwork ventilation system that distributes the conditioned air through the building and returns it to the air handler.

The inventor has dealt with HVAC systems and air handlers for many years. The inventor knew that sometimes the piping in the HVAC system would leak, requiring the leaking fluids to be captured and disposed of The inventor also knew that often, the air handler accumulates dust and fibers as a result of the constant flow of air. Thus, the inventor saw that the air handler inner walls and the cooling and heating coils were often washed out with chemicals and pressurized fluids periodically. This washing process creates a flow of fluid and waste that must be disposed or it will accumulate inside the air handler.

The inventor was also aware that, specifically, air conditioner air handlers required regular care and maintenance. This involved the continual changing of an inlet air filter. The inventor knew that air filters were changed typically every one to six months. The inventor saw however that many persons fail to change their filters or clean their air handler properly, causing damage to the air handler.

The inventor decided to replace the filter frame with a panel frame containing a resilient panel. This temporary positioning of the panel towards a lower region of the air handler would catch drips from a leaking pipe, or accumulated fluid and waste form cleaning. However, the inventor saw that the fluid and waste remained in the panel.

The inventor noted that when cleaning the coils and walls in the air handler with high pressure fluids and chemicals, the panel positioned beneath the coils and inner walls of the air handler to more efficiently capture the accumulated and runoff fluid and chemical waste. However, the inventor noticed that the HVAC unit still required powering off before the panel can be used in the air handler. This was necessary since the air flow can disrupt the positioning of the receptacle, i.e., blowing the receptacle out of position.

The inventor decided to resolve this issue. After performing research, the inventor learned that a longitudinal cavity could carry a liquid or gas, especially if gravity helped with movement. The inventor decided to integrate a single directional tube into the panel. The inventor made the tube flexible so it could carry the fluid and waste to a discharge container.

The inventor also saw a problem in that the frame rack was often not operational. Thus, the inventor deiced to include holes and magnetic straps to the periphery of the panel to enable mounting, when the panel frame could not slide in and out of the filter rack.

For the foregoing reasons, there is an air handler cleaning receptacle for collecting fluid and waste that leak from an HVAC unit, or that accumulate while cleaning an air handler.

Receptacles for capturing fluid runoff from HVAC systems in air handlers have been utilized in the past; yet none with the characteristics of the present invention. See U.S. Pat. No. 9,080,786; U.S. Pat. No. 8,985,635; and US 20130047642.

For the foregoing reasons, there is an air handler cleaning receptacle detachably attach inside the air handler, such that it can be reused, carried easily, and adapted for operation with various sizes and styles of air handlers for collecting fluid and waste that leak from an HVAC unit, or that accumulate while cleaning an air handler and components thereof.

### SUMMARY

The present invention describes an air handler cleaning receptacle for collecting fluid and waste that leak from an HVAC unit, or that accumulate while cleaning an air handler and components thereof. The air handler cleaning receptacle, hereafter, “receptacle” is configured to detachably attach inside the air handler, such that it can be reused, carried easily, and adapted for operation with various sizes and styles of air handlers. Specifically, the receptacle is configured to attach to a filter rack in the air handler, and slide in and out of the filter rack during operation and after use. The receptacle not only captures excess fluid and waste, but also funnels the fluid and waste to a discharge container r for disposal.

The receptacle may include a panel frame. In some embodiments, the panel frame comprises a generally closed perimeter area and a flange. The closed perimeter area of the panel frame may form a rigid configuration and have a substantially rectangular or square shape. The flange of the panel frame provides a supportive platform for sliding into the filter rack and for supporting a panel.

The panel frame may include a rigid configuration and a substantially rectangular shape. The panel frame is configured to slidably position in a filter rack of an air handler. The receptacle further includes a panel that works in conjunction with the panel frame. The panel is configured to substantially catch the fluid and waste that accumulates in the air handler during cleaning of the air handler.

The panel includes a front end, a rear end, and a periphery portion. The front end of the panel is disposed towards an access point in the air handler. The rear end of the panel is disposed distally from the access point, towards a distal region of the air handler. The periphery portion of the panel is configured to securely join with the flange of the panel frame. In this manner, the panel is configured to stretch across the entirety of the panel frame. In one embodiment, the panel stretches loosely across the panel frame, such that the weight of a fluid and waste causes the panel to sag concentrically.

The periphery portion of the panel comprises a plurality of magnetic fasteners that positions at the rear end of the panel. The magnetic fasteners enable attachment of the panel frame and the panel to the distal region of the air handler. The magnetic fasteners may be useful when the filter rack is inoperable or not available.

The periphery portion further comprises at least two holes that position at the front end of the panel for receiving an external fastener, such as a hook. The external fastener may pass through the at least two holes from a frontal area of the air handler, such as near an entry door. In one embodiment, the holes may also serve as a base for the magnetic fasteners at the rear end of the panel.

In some embodiments, at least one tube may extend perpendicularly from the panel. The tube includes an inlet, a longitudinal cavity, and an outlet. The inlet provides an opening that enables the fluid and waste to pass through the longitudinal cavity of the tube. The tube is configured to enable single directional flow of the fluid and waste. This single directional flow is configured so that the tube can carry fluid and waste away from the panel and towards a discharge container.

Thus in operation, the filter frame, filter, and other accessories are initially removed from the air handler. The panel frame slides into a filter rack that is disposed generally beneath the leak, or the accumulated fluid and waste. The panel catches the fluid and waste and directs the fluid and waste towards the inlet of the tube. The longitudinal cavity of the tube is sufficiently resilient so as to conform to multiple directions for carrying the fluid and waste to the outlet that leads to a discharge container. The fluid and waste in the discharge container may be disposed of accordingly. After the leak is sealed, or the air handler cleaned sufficiently, the filter frame, filter, and accessories may then be returned for normal HVAC operation.

One objective of the present invention is to provide a detachable receptacle for capturing accumulated water, chemicals, and debris from the inside of an air handler during cleaning or while the piping is leaking.

Another objective of the present invention is to provide a receptacle that detachably slides in and out of a filter rack in an air handler.

Another objective of the present invention is to provide a plurality of magnetic fasteners that fasten outside the air handler, such that the panel frame and the attached panel are securely attached thereto.

Yet another objective of the present invention is to provide at least two holes the can receive a hook for securing the back end of the panel and panel frame to the distal region inside the air handler.

Yet another objective is to provide a resilient panel that conforms to the weight of the fluid and waste.

Yet another objective is to provide a tube that is flexible, so as to direct the fluid and waste to the discharge container.

Yet another objective is to provide a portable air handler cleaning receptacle.

Yet another objective is to provide an inexpensive to manufacture air handler cleaning receptacle.

### DRAWINGS

These and other features, aspects, and advantages of the present invention will become better understood with regard to the following description, appended claims, and drawings where:

FIGS. 1A and 1B are perspective views of an exemplary air handler cleaning receptacle, where FIG. 1A is a top angle view, and FIG. 1B is a sectioned view; and

FIG. 2 is a perspective view of an exemplary air handler cleaning receptacle installed in an exemplary air handler, with a filter rack removed from a filter frame.

### DETAILED DESCRIPTION

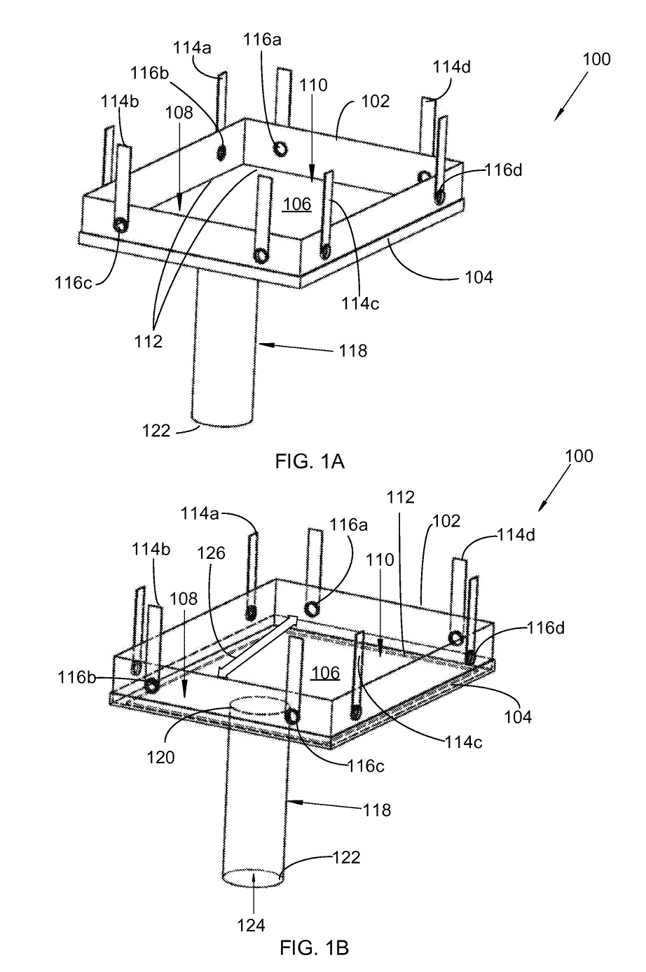

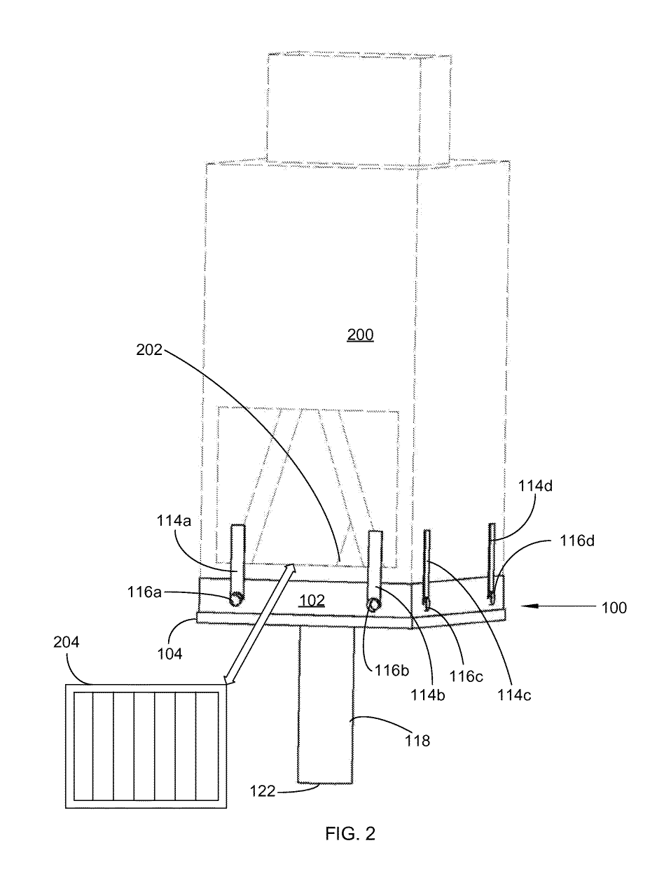

The present invention, referenced in FIGS. 1A-2, is directed to an air handler cleaning receptacle 100 for collecting fluid and waste that leak from an HVAC unit, or that accumulate while cleaning an air handler 200 and components thereof. The air handler cleaning receptacle 100, hereafter, “receptacle 100” is configured to detachably attach from inside an air handler 200, such that the receptacle 100 can be reused, carried easily, and adapted for operation with various sizes and styles of air handlers. Specifically, the receptacle 100 is configured to attach to a filter rack 204 in the air handler 200, and slide in and out of the filter rack 204 during operation and after use. The receptacle 100 not only captures excess fluid and waste, but also funnels the fluid and waste to a discharge container (not shown) for disposal.

Those skilled in the art will recognize that an air handler 200 is a device used to regulate and circulate air as part of a heating, ventilating, and air-conditioning (HVAC) system. The air handler 200 is usually a large metal box containing a blower, a heating or cooling mechanism, a cooling and heating coil, a filter rack for retaining a filter, and a sound attenuator and damper.

The air handler 200 connects to a ductwork ventilation system that distributes the conditioned air through the building and returns it to the air handler 200. Often, the air handler 200 accumulates dust and fibers as a result of the constant flow of air. Thus, the air handler inner walls and the cooling and heating coils must be washed out with chemicals and pressurized fluids periodically. This creates a flow of fluid and waste that must be disposed or it will accumulate inside the air handler 200. Additionally, the piping in the HVAC system often leaks, requiring the leaking fluids to be captured and disposed of in an efficient manner.

As the receptacle 100 configuration of FIGS. 1A and 1B reference, when cleaning the coils and walls in the air handler 200 with high pressure fluids and chemicals, the receptacle 100 positions beneath the coils and inner walls of the air handler 200 to more efficiently capture the accumulated and runoff fluid and chemical waste. Those skilled in the art will also recognize that the HVAC unit must be powered off before the receptacle 100 can be used in the air handler 200. This is necessary since the air flow can disrupt the positioning of the receptacle 100, i.e., blowing the receptacle 100 out of position. Further, a filter rack 204 must be removed from the filter frame 202 to enable installation of the receptacle 100 in the filter frame 202.

As illustrated in FIG. 2, the receptacle 100 is configured to detachably integrate into the filter frame 202 of the air handler 200. In one embodiment, the receptacle 100 comprises a panel frame 102. The panel frame 102 is configured to slidably position in the filter rack 204 of the air handler 200. The panel frame 102 may be sized and dimensioned to fit into a standard size air handler, or variously sized and dimensioned air handlers.

Looking back at FIG. 1B, the panel frame 102 comprises a generally closed perimeter area 126 and a flange 104. The closed perimeter area 126 of the panel frame 102 may form a secure perimeter having rigid configuration. The closed perimeter area 126 may have a substantially rectangular or square shape. The panel frame 102 includes a flange 104 that provides a supportive platform for sliding into the filter rack 204, and also for supporting a panel 106. In one alternative embodiment, the panel frame 102 is size adjustable, whereby the panel frame 102 telescopically increases or decreases in size. Suitable materials for the panel frame 102 may include, without limitation, aluminum, steel, metal alloys, wood, fiberglass, and a rigid polymer.

The receptacle 100 further includes a panel 106 that works in conjunction with the panel frame 102. The panel 106 is configured to stretch within the closed perimeter area 126 of the panel frame 102. In one embodiment, the panel 106 rests on the flange 104 of the panel frame 102. The panel 106 is configured to substantially catch the fluid and waste that accumulates in the air handler 200 during cleaning of HVAC components in the air handler 200, and also to catch leaking fluids that drip from piping in the HVAC system. Thus in one exemplary use, while cleaning the walls and coil in the air handler 200 with pressurized fluid and chemicals, the panel 106 is configured to capture and funnel the accumulated fluid and waste to a discharge container.

As FIG. 1A illustrates, the panel 106 may include a front end 108, a rear end 110, and a periphery portion 112. The front end 108 of the panel 106 is disposed towards an access point in the air handler 200. The access point may include a door that faces a user. The rear end 110 of the panel 106 is disposed distally from the access point, towards a distal region of the air handler 200. The periphery portion 112 of the panel 106 is configured to securely join with the panel frame 102. In this manner, the panel 106 stretches across the entirety of the panel frame 102. In one embodiment, a fastening mechanism, such as tape, an adhesive, or a plurality of screws fastens the periphery portion 112 of the panel 106 to the panel frame 102.

In one embodiment, the panel 106 stretches loosely across the panel frame 102. This loose disposition enables the weight of a fluid and waste to cause the panel 106 to sag towards a center area of the panel 106. In one alternative embodiment, the panel 106 does not integrate into the panel frame 102, but rather fastens into the perimeter section of the filter frame 202 inside the air handler 200. In either case, the panel 106 has substantially the same dimensions as the filter frame 202. Suitable materials for the panel 106 may include, without limitation, polyurethane, vinyl, plastic, a tightly woven fabric, and a semi-rigid polymer.

As depicted in FIG. 2, the panel 106 utilizes various fastening mechanisms for secure fastening to the air handler 200 while installed therein. In one embodiment, the periphery portion 112 of the panel 106 comprises a plurality of magnetic fasteners 114a, 114b, 114c, 114d that positions at the rear end 110 of the panel 106. The magnetic fasteners 114a, 114b, 114c, 114d enable attachment of the panel frame 102 and the panel 106 to the distal region of the air handler 200. The magnetic fasteners 114a, 114b, 114c, 114d may be useful when the filter rack 204 is inoperable or not available. In one embodiment, the magnetic fasteners 114a, 114b, 114c, 114d are magnetically charged straps that extend a sufficient distance to overlap the outside of the air handler 200.

The periphery portion 112 further comprises at least two holes 116a, 116b, 116c, 116d that position at the front end 108 and/or the rear end 110 of the panel 106. The holes 116a, 116b, 116c, 116d are configured to receive an external fastener, such as a hook. For example, the hook may pass through two holes 116a, 116b from a frontal area of the air handler 200, such as near an entry door. In one embodiment, the holes 116a, 116b, 116c, 116d may also serve as a base for the magnetic fasteners 114c, 114d at the rear end 110 of the panel 106. In another embodiment, the holes 116a, 116b, 116c, 116d are reinforced with a plastic grommet.

The at least two holes 116a, 116b, 116c, 116d may receive a hook for mounting the receptacle 100. The hook may be disposed inside the air handler 200, while overhanging the receptacle 100. The magnetic fasteners 114a, 114b, 114c, 114d also enable mounting the receptacle 100 in the air handler 200. The magnetic fasteners 114a, 114b, 114c, 114d may extend outside the air handler 200 to attach to the outer walls of the air handler 200 for mounting. The holes 116a, 116b, 116c, 116d and magnetic fasteners 114a, 114b, 114c, 114d are especially effective when the filter rack 204 is not operational to slidably receive the flange 104 of the panel frame 102.

In some embodiments, at least one tube 118 may extend perpendicularly from the panel 106. The tube 118 may be disposed at the front end 108 of the panel 106. Though the tube 118 may also position at the rear end 110 in some embodiments. The tube 118 is flexible, so as to easily orient in a desired direction for funneling the fluid and waste. The at least one tube 118 includes an inlet 120, a longitudinal cavity 124, and an outlet 122. The inlet 120 provides an opening that enables the fluid and waste to pass from the panel 106 and through the longitudinal cavity 124 of the tube 118. The tube 118 is configured to enable single directional flow of the fluid and waste. This one directional flow is configured so that the tube 118 can carry fluid and waste away from the panel 106 and towards a discharge container.

Suitable materials for the tube 118 may include, without limitation, polyurethane, vinyl, plastic, a tightly woven fabric, and a semi-rigid polymer. In one alternative embodiment, the tube 118 may telescopically extend and retract. In one embodiment, the longitudinal cavity 124 has a diameter between about 2-24″. In another embodiment, the tube 118 is between about 1-4′ long.

Thus in operation, the filter frame 202, the filter, and other accessories are initially removed from the air handler 200. The panel frame 102 slides into a filter rack 204 that is disposed generally beneath the leak, or the accumulated fluid and waste. The panel 106 catches the fluid and waste and directs the fluid and waste towards the inlet 120 of the tube 118. The longitudinal cavity 124 of the tube 118 is sufficiently resilient so as to conform to multiple directions for carrying the fluid and waste to the outlet 122 that leads to a discharge container. The fluid and waste in the discharge container may be disposed of accordingly. After the leak is sealed, or the air handler 200 cleaned sufficiently, the receptacle 100 is removed, and the filter frame 202, filter, and accessories may then be returned for normal HVAC operation.

While the inventor's above description contains many specificities, these should not be construed as limitations on the scope, but rather as an exemplification of several preferred embodiments thereof. Many other variations are possible. For example, the panel 106 may be rigid, rather than flexible, and the tube 118 may telescopically extend and retract. Accordingly, the scope should be determined not by the embodiments illustrated, but by the appended claims and their legal equivalents.

What is claimed is:

1. An air handler cleaning receptacle for collecting fluid and waste from an air handler, the receptacle comprising:
a panel frame, the panel frame comprising a generally closed perimeter area, the panel frame further comprising a flange, the flange configured to enable slidable mounting of the receptacle;
a panel, the panel comprising a front end, a rear end, and a periphery portion, the panel configured to extend within the closed perimeter area of the panel frame, the periphery portion configured to join with the flange;
at least two holes, the at least two holes disposed at the periphery portion of the panel, the at least two holes configured to enable mounting of the receptacle;
a plurality of magnetic fasteners, the plurality of magnetic fasteners disposed at the periphery portion of the panel, the plurality of magnetic fasteners configured to enable mounting of the receptacle; and
a tube, the tube comprising an inlet, a longitudinal cavity, and an outlet, the tube disposed to extend generally perpendicular from the front end of the panel, the tube configured to enable single directional flow.

2. The receptacle of claim 1, wherein the panel frame has a generally rectangular or square shape.

3. The receptacle of claim 1, wherein the panel frame is configured to enable slidable engagement with a filter rack.

4. The receptacle of claim 1, wherein the panel frame is fabricated from a metal.

5. The receptacle of claim 1, wherein the flange is about one inch long.

6. The receptacle of claim 1, wherein the panel is resilient.

7. The receptacle of claim 1, wherein the panel is fabricated from a polythene or nylon material.

8. The receptacle of claim 1, wherein the panel is sized and dimensioned to fit within the closed perimeter area of the panel frame.

9. The receptacle of claim 1, wherein the panel has a generally rectangular or square shape.

10. The receptacle of claim 1, wherein the front end of the panel is disposed towards an access point of the air handler.

11. The receptacle of claim 1, wherein the at least two holes is six holes.

12. The receptacle of claim 1, further including a grommet, the grommet configured to reinforce the at least two holes.

13. The receptacle of claim 1, wherein the plurality of magnetic fasteners are magnetic straps.

14. The receptacle of claim 1, wherein the tube is fabricated from a resilient polythene or nylon material.

15. The receptacle of claim 1, further including a discharge container, the discharge container configured to receive a fluid and a waste that flows from the outlet of the tube.

16. The receptacle of claim 1, further including a hook, the hook configured to pass through the at least two holes for mounting the receptacle in the air handler.

17. An air handler cleaning receptacle for collecting fluid and waste from an air handler, the receptacle comprising:
a panel frame, the panel frame comprising a generally closed perimeter area, the panel frame further comprising a flange, the flange configured to enable slidable mounting of the receptacle;
a panel, the panel comprising a front end, a rear end, and a periphery portion, the panel configured to extend within the closed perimeter area of the panel frame, the periphery portion configured to join with the flange;
a panel fastener, the panel fastener configured to fasten the periphery portion of the panel to the flange of the panel frame;
at least two holes, the at least two holes disposed at the periphery portion of the panel, the at least two holes configured to enable mounting of the receptacle;
a plurality of magnetic straps, the plurality of magnetic straps disposed at the periphery portion of the panel, the plurality of magnetic straps configured to enable mounting of the receptacle; and
a tube, the tube comprising an inlet, a longitudinal cavity, and an outlet, the tube disposed to extend generally perpendicular from the front end of the panel, the tube configured to enable single directional flow.

18. The receptacle of claim 17, further including a hook, the hook configured to pass through the at least two holes for mounting the receptacle in the air handler.

19. The receptacle of claim 17, wherein the panel and the tube are resilient.

20. The receptacle of claim 17, further including a discharge container, the discharge container configured to receive a fluid and a waste from the outlet of the tube.
